(19) United States
(12) Patent Application Publication
(10) Pub. No.: US 2003/0220825 A1
(43) Pub. Date: Nov. 27, 2003

(54) Enterprise organization management system control device

(76) Inventor: Shon-Min Tseng, Taipei (TW)

Correspondence Address: BACON & THOMAS, PLLC, 625 SLATERS LANE, FOURTH FLOOR, ALEXANDRIA, VA, 22314

(21) Appl. No.: 10/150,996

(22) Filed: May 21, 2002

(51) Int. Cl. G06F 17/60

(52) U.S. Cl. 705/8

(57) ABSTRACT

An enterprise organization management system control device is provided. The enterprise organization management system control device facilitates the easy and correct definition and redefinition operations on connections between members of the organization and functions of the enterprise organization management system, through the modulation of the groups of members under the enterprise organization, the roles of the members and the operable functions of the enterprise organization management system. The enterprise organization management system control device comprises a member management module, a group management module, a role management module, a subroutine management module and a function management module. A member-group-role look-up-table, a group-subroutine look-up-table and a rule-function look-up-table are generated through the operation of the enterprise organization management system control device of this invention, to facilitate the management and safety of the enterprise organization management system.

### FIELD OF INVENTION

The present invention relates to an enterprise organization management system control device, especially to a safety control or authorization control device for the enterprise organization management system. This invention is especially applicable in a safety control or authorization control device for an enterprise organization management system using a computer hardware and software system to include the organization and the operation of an enterprise into one single management system.

### BACKGROUND OF INVENTION

In an enterprise, the enterprise organization management system using a computer system to include all the members and the daily operations of the enterprise into one single system, has become a popular tool. In such an enterprise organization management system, all the members of enterprise, and even members who don't belong to the enterprise, are included in the system and are allowed to conduct their daily operations in said system.

In an enterprise organization management system each “member” is given a member code, is connected to one or more “groups” under a classification system and is connected to a plurality of “functions” as provided in the management system. Each single “member” is given (defined) a level of authorization in relating to a “function”. Each single “member” is given (defined) a “supervisor” who is another member as included in the system. As a result, each member is allowed to operate with functions, as provided in the management system and given to him/her, within the given authority, so to conduct his/her daily operations. Every member is supervised by one or more supervisors, through the management system. If the functions given to one member needs to be added, modified or deleted, the operation may be easily accomplished by the competent supervisor(s) through the application interface of the management system. The adding, modification and deletion of functions and authorization given to a member are also defined as operations under the enterprise organization management system.

Although the conventional enterprise organization management system provides these useful functions and, thus, is welcomed by the industry, it has several problems to be solved.

For example, in the conventional enterprise organization management system, functions as given to a member are connected directly to the member. When the “group” to which the member belongs is changed the connections need to be redefined. Although the redefinition may be conducted in a function table or user interface of the management system, it is always difficult for an operator or a supervisor to exhaustedly allocate all the connections needed to be modified. When some omissions exist, some functions that should be designated to a member due to his/her new position are not operating. On the other hand, if the supervisor fails to delete connections that no longer needed for the new position, he/she will be able to operate some functions which he/she is not allowed to operate. Modification is thus needed.

In addition to that, during the expansion of an enterprise, new functions are added to the enterprise organization management system from time to time. As the number of the new functions increases, the burden of the computer system will increase, if the new functions are not managed in a systematical manner.

A problem that will exist in such a conventional enterprise organization management system is, even one member belongs to a group (department) under the structure of the enterprise organization, the member may belong to another group or department, permanently or temporarily, due to the need of his/her job designation. In such a case, new definitions shall be made to the connections between that member and the other group, the other group of functions and another supervisor. As a result, functions operable by the member in his/her daily operations may overlap among them. Problems so arisen include indefinite authorization, wrong route of submission of documents or no rout available for submission of documents, misuse of authorization, non-existence of supervisor, disclosure of confidential information etc. Especially when one member has different levels of authorization for the same function in different groups, the computer program may not be operable due to the confusion in the level of authorization.

Nevertheless, when new functions are provided in the enterprise organization management system, the operator may have the chance to give wrong definitions in the connections of such new functions with members, since the computer system does not supervise the operator in that operation.

It is thus necessary to provide a novel enterprise organization management system control device to strengthen the safety control and/or the authorization control of the enterprise organization management system.

It is also necessary to provide an enterprise organization management system control device to facilitate the easy and correct definition operation of the change in the connections between members and functions provided in the management system and operable by the members, when the functions operable by the member shall be changed

It is also necessary to provide an enterprise organization management system control device to correctly control the authorization given to a member in respect to the functions provided in the management system, when the member is defined connected to two or more groups under the enterprise organization.

### OBJECTIVES OF INVENTION

The objective of this invention is to provide a novel enterprise organization management system control device to strengthen the safety control and/or the authorization control of the enterprise organization management system.

Another objective of this invention is to provide an enterprise organization management system control device to facilitate the easy and correct definition operation of the change in the connections between members and functions provided in the management system and operable by the members, when the functions operable by the member shall be changed.

Another objective of this invention is to provide an enterprise organization management system control device to correctly control the authorization given to a member in respect to the functions provided in the management system, when the member is defined connected to two or more groups under the enterprise organization.

### SUMMARY OF INVENTION

According to this invention, an enterprise organization management system control device is provided. The enterprise organization management system control device of this invention facilitates the easy and correct definition and redefinition operations on connections between members of the organization and functions of the enterprise organization management system, through the modulation of the groups of members under the enterprise organization, the roles of the members and the operable functions of the enterprise organization management system. As a result, no matter how the connections between a member and a group, between a member and a function or between a member and a level of authorization changes, the change may be easily reflected in the enterprise organization management correctly. The enterprise organization management system control device of this invention comprises a member management module, a group management module, a role management module, a subroutine management module and a function management module. A member-group-role look-up-table, a group-subroutine look-up-table and a rule-function look-up-table are generated through the operation of the enterprise organization management system control device of this invention, to facilitate the management and safety of the enterprise organization management system.

The above and other objectives and advantages of this invention may be clearly understood from the detailed description by referring to the following drawings.

### BRIEF DESCRIPTION OF DRAWINGS

In the drawings,

FIG. 1 illustrates the system diagram of the enterprise organization management system control device of this invention.

FIG. 2 illustrates the flow chart in the “adding new member” operation applicable in the enterprise organization management system control device of this invention.

### DETAILED DESCRIPTION OF INVENTION

The following is a detailed description of the enterprise organization management system control device of this invention.

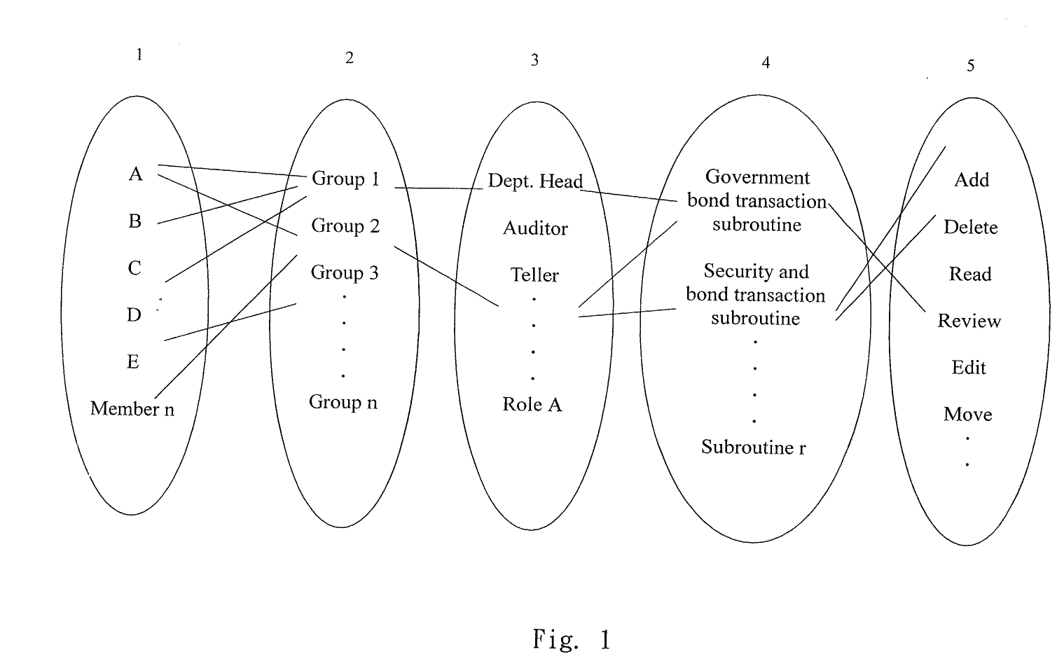

Please refer to FIG. 1. FIG. 1 illustrates the system diagram of the enterprise organization management system control device of this invention. As shown in this figure, the enterprise organization management system control device of this invention comprises: a member management module 1, a group management module 2, a role management nodule 3, a subroutine management module 4 and a function management module 5. The functions and operations of these modules will be described below.

Member Management Module

The function of the member management module 1 is to manage all the members of the enterprise organization. Here, the term “member” pertains to any user that is allowed to access to the enterprise organization management system. As a result, anyone who is allowed to access the enterprise organization management system is defined as a “member” in the enterprise organization management system control device of this invention. A member is not necessarily a person. A “group” under the enterprise organization may also be defined as a member.

In the embodiment of this invention, a member is defined and recorded as the name or the code of a member and its connections with other management modules in the enterprise organization management system control device of this invention. As shown in FIG. 1, members A, B, . . . N are included in this member management module 1 and individual members are connected to the corresponding components of other management modules 2-5.

In the member management module 1, as well as in other management modules 2-5, a user interface (not shown) is provided, allowing users to review, add, modify and/or delete content and components of the module.

Group Management Module

The function of the group management module 2 is to manage the groups to which members of an enterprise organization are connected. In the present invention, a “group” is established or defined, whenever a number of members are defined to be connected to a group and their respective “roles” (to be described hereinafter) in that group are designated. Each “group” shall have at least one “leader” but the number of members of a group is not necessarily more than one. If a group is governed under a joint leadership (e.g., decisions are made through a proxy of a committee), more than one member is defined as “leaders”. In addition, one or more “supervisor”, “administrator” or other roles may also be defined and designated. Other members may be classified as “operators”. Members of a group include persons who are allowed to access to the enterprise organization management system, members of the enterprise organization and groups under the group management module 2. The only restrictions are that a group may not be a member of itself and that anyone who is not defined in the member management module 1 is not allowed to be defined as a member of any group in the group management module 2. As to the corresponding connections between members in the member management module 1 and the groups in the group management module 2, any member in the member management module 1 may be defined to be connected to more than one group in the group management module 2. In FIG. 1 it is shown that connections are defined between members A, B, . . . N in the member management module 1 and Groups I, II, . . . M in the group management module 2.

Role Management Module

The function of the role management module 3 is to manage the roles of members belonging to the member management module 1, in the groups of the group management module 2. In the embodiment of this invention, all functions or authorization within one “group” or department of one enterprise organization are modulated into several types. For example, the enterprise organization as shown in FIG. 1 is an enterprise organization in the financial services, such as a bank. In such an enterprise organization, all roles in all groups are classified into “leader”, “supervisor”, “teller”, . . . and “role p”. Any member of a group may be connected to at least one of the roles, after the connection is defined. For example, a member of a bank may be a teller and a leader at the same time. Of course, a supervisor may not be a leader or a teller at the same time.

Subroutine Management Module

The function of the subroutine management module 4 is to define subroutines or subsystems of the enterprise organization system that at least one member of a group needs to use. Here, the term “subroutine” or “subsystem” pertains to operational functions of all application software as provided in the computer system of the enterprise organization. These operational functions are define as “subroutines” or “subsystems” when they are designed and/or installed and calling tools therefor are provided. However, to provide a conversion interface to define a certain computer program as a subroutine, such that users may call the subroutine, is also an applicable way. In the financial service organization as shown in FIG. 1, the subroutines provided in the subroutine management module 4 include “government bond transaction subroutine”, “security and bond transaction subroutine”, . . . , “subroutine r” etc. In other business, the subroutines will be defined according to the needs in the application. In the present invention, the subroutine management module 4 provides definitions of connections between groups in the group management module 2 and the subroutines in the subroutine management module 4. In other words, all the subroutines that at least one member of a group needs to use are connected to that particular group. If an existing definition of such connection needs to be modified, the modification shall be made through the operation of the enterprise organization management system control device of this invention. So is the operation to define the connections.

Function Management Module

The function of the function management module 5 is to provide definition of connections between functions of a subroutine and members of a group, i.e., the authorization given to the member in using that subroutine. As described above, the functions of a subroutine are modulated and classified into several modules, according to the role of a member in a group. The modules of the functions include: adding, modification, deletion, review etc. In the embodiment of this invention, the functions included in the function management module 5 are already defined by the administrator of the enterprise organization system in advance. As a result, for any role in a group, the functions accessible to him/her (i.e., the functions connected to his/her role in his/her group) are already defined and his/her authorization to access to the function or the subroutine has been defined. For example, when a member is leader of the group, functions connected to him/her include all functions except “adding”. When a member is a supervisor, only the “review” function is connected to his/her role. As to an ordinary teller, the functions of “adding” and “modification” are accessible.

Because all the functional connections are defined in advance, any change to the functional connection may only be made under special authorization. The operation of the authorization shall be made under the operation of the enterprise organization management system control device of this invention. So is the prior definition operation of the functional connections.

After the above definition operations and authorization operations, one or more tables or one or more groups of tables, recording the defined connections between or among items included in the management modules 1-5, are generated. These tables include: a “member-group-role look-up-table”, a “group-subroutine look-up-table”, a “group-role-function look-up-table” etc. Each table may be designed based on a section of the table, i.e., “member”, “group”, “role”, “subroutine”, “function” etc. The content of such look-up-tables may be understood by those skilled in the art.

Detailed Description Thereof is Thus Omitted.

In one embodiment of this invention, a “role-subroutine-function look-up-table” is generated. In another embodiment of this invention, members are connected to their roles directly. In such a case, a “member-group-role look-up-table” is generated.

Under the above operation, as shown in FIG. 1, member A of an enterprise is defined as “Member A” in the member management module 1. In the group management module 2, Member A is defined to be connected to Group 1, Group 2 and Group 3. In the role management module 3, Member A's role in Group 1 is defined as “leader” and “teller”, since member A is leader of Group 1 and is also a teller in that group. In addition, both the “government bond transaction subroutine” and the “security and bond transaction subroutine” are accessible to members belonging to Group 1. As a result, in the subroutine management module 4, defined are connections between these subroutines and Group 1. Also, in the function management module 5, defined are connections between “leader” in the role management module 3 and functions “delete”, “modification” and “review” in the function management module 5. All other members of the enterprise organization are given definitions of all related connections. As a result the authorizations given to all members of this enterprise organization to use particular functions of the subroutines are correctly defined.

When the relation between a member and a group is changed, the connection between this member and the group, and the connection between this member and the member's role in that group, is redefined. If the connection between a member and a group is deleted, the member is not allowed to access to any subroutine and function connected to that group. If the connection between a member and a group, and the member's role in that group, is added, the member is allowed to use the functions of the subroutines as connected to that group, according to the role of the member in that group. Such operations may be easily accomplished using a well-known user interface and a well-known computer program. Similar operations are made, when the role of a member in one group is changed, when a group is added or deleted, when a role is added into or deleted from a group or when a subroutine or a function is added, modified or deleted.

### Embodiment

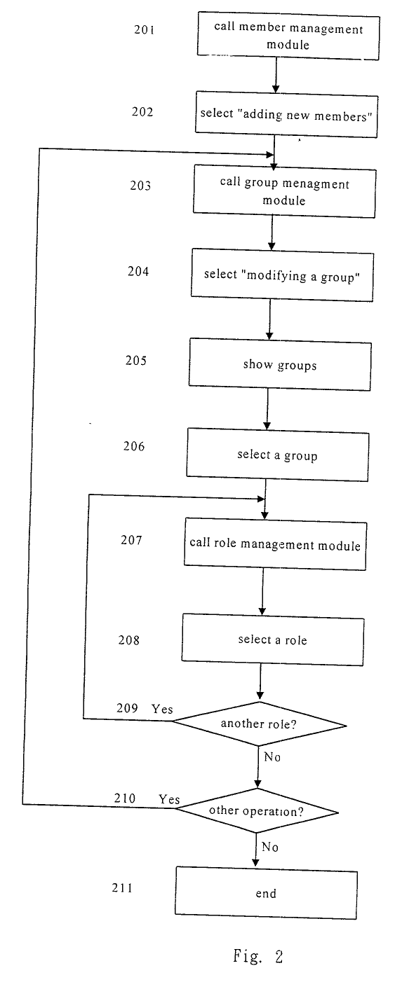

In order to show the operation of the enterprise organization management system control device of this invention, an example in adding a new member into the system is described. FIG. 2 shows the flow chart of the “adding new member” operation applicable in the enterprise organization management system control device of this invention.

As shown in this figure, when a new member joins an enterprise, at 201 the member management module 1 of this invention is called and a user interface is shown on the screen of the computer device (not shown) running the enterprise organization management system control device. At 202, the operator selects the “adding new members” function under the member management module 1. In this member management module 1, other functions such as “deleting a member”, “modify a member” and “reviewing a member” are provided. After the “adding new members” function is called, at 203 the group management module 2 is called and the user interface of the group management module 2 is shown. In the user interface of the group management module 2, functions including “deleting a group”, “adding a group”, modifying a group” and “reviewing a group” are provided. At 204 the operator selects the “modifying a group” function and at 205 all existing groups (Group 1-Group n) are shown. At 206, a group is selected by the operator. Thereafter, at 207 the role management module 3 is called and the user interface of the role management module 3 is shown. In the user interface of the role management module 3, all the existing roles are shown. At 208, the operator selects a role. The system requests the operator to confirm whether all the applicable roles are selected at 209, since in the present invention one member may be connected to a plurality of roles in one group. If another role shall be selected, the operation returns to step 207 and steps 207 and 208 are repeated. Otherwise, the system requests the operator to confirm whether another group needs to be connected or added-and-connected at 210. If the message of the operator is yes, the operation returns to step 203; otherwise, the operation ends at 211.

After the above operation, the group(s) connected to the new member and the role(s) of the member in the group(s) are defined. As a result, the authorization given to the member based on the member's connections to the related group(s) and to the role(s) in the group(s), i.e., the subroutines accessible to the member and the scope of functions in the subroutines accessible to the member are already defined.

### Effects of Invention

As described above, the enterprise organization management system control device of this invention allows users to easily and correctly add, delete and/or modify a member, the member's groups and the functions of subroutines accessible to the member. This invention provides explicit, easy and safe management functions to the enterprise organization management system. With the functions of the present invention, the problems rest in the conventional enterprise organization management system, especially when a member belongs to a plurality of groups (departments), when a new group needs to be added, when the relation of a member to a group needs to be changed and when the role of a member in a group needs to be changed, may be easily solved.

As the present invention has been shown and described with reference to preferred embodiments thereof, those skilled in the art will recognize that the above and other changes may be made therein without departing form the spirit and scope of the invention.

What is claimed is:

1. An enterprise organization management system control device, comprising:
a member management module to provide a user interface and a review and modification tool, allowing a user to review the personal information of a defined “member” and/or to add, modify and/or delete at least a part of said personal information;
a group management module to define the connections between a defined “member” and at least one defined “group” comprising at least one defined “member” and to provide a user interface and a review and modification tool, allowing a user to review the group information of defined “groups” and/or to add, modify and/or delete a defined “group” and/or at least a part of said group information;
a role management module to define the connections between at least one defined “role” and a defined “member” connected to a particular defined “group”;
a subroutine management module to define the connections between a define “group” and at least one defined “subroutine” comprising an application program provided in said enterprise organization management; and
a function management module to define the connections between a group of defined “functions” as provided in said at least one “subroutine” and said at least one defined “subroutine” and the connections between said group of defined “functions” and said at least one defined “role”;
characterized in that said group of defined “functions” is operable by said defined “member”, only when said group of “functions” is defined being connected to said defined “member”.

2. The enterprise organization management system control device according to claim 1, wherein said connections between said group of “functions” and said defined “role” comprises connections among said group of “functions”, said defined “subroutine” and said defined “role”.

3. The enterprise organization management system control device according to claim 1, wherein said connections between said group of “functions” and said defined “role” comprises connections among said group of “functions”, said defined “group” and said defined “role”.

4. The enterprise organization management system control device according to claim 1, wherein said function management module further provides a user interface and a review and modification tool, allowing users to review, add, modify and/or delete a defined “function”, a group of defined “functions”, the connections between a group of defined “functions” and a defined “role” or the connections between a group of defined “functions” and a defined “subroutine”.
